(19) United States
(12) Patent Application Publication
(10) Pub. No.: US 2019/0061938 A1
(43) Pub. Date: Feb. 28, 2019

(54) RADIO FREQUENCY STEALTHY TETHERED AIRCRAFT

(71) Applicant: APPLIED SIGNALS INTELLIGENCE, INC., Sterling, VA (US)

(72) Inventor: John W. McCorkle, Vienna, VA (US)

(21) Appl. No.: 16/117,074

(22) Filed: Aug. 30, 2018

Related U.S. Application Data
(60) Provisional application No. 62/551,854, filed on Aug. 30, 2017.

(51) Int. Cl. B64C 39/02; H01Q 1/22

(52) U.S. Cl. CPC B64C 39/022; B64C 2201/148; H01Q 1/22

(57) ABSTRACT

A tethered aircraft is provided in which the conductive tether is broken into two or more sections and where at least one section is an RF-isolating section that acts to reduce or control RF current flow on the tether. Reducing the RF current flow reduces the interaction of the tether with incoming RF waves. This allows reduced radar cross-section and reduced reflections that inhibit the performance of RF payloads, such as direction finding. The RF-isolating sections also allow RF currents to be controlled, such as forcing current to flow in a desired location to form an antenna built into the tether. The disclosure identifies 4 different RF-isolating sections to allow optimization for weight and frequency band coverage. The application of using sectioned tethers, as disclosed here, is useful not only for tethers that convey power, but also for tethers that serve other purposes, such as conveying information and signals.

### BACKGROUND

A rotorcraft is a rotary-wing aircraft supported in flight by the reactions of the air on one or more rotors, like a helicopter. Tricopter, quadcopter, hexacopter and octocopter are frequently used to refer to 3-, 4-, 6- and 8-rotor helicopters, respectively. These rotorcrafts are also referred to as multicopters. There has been explosive growth in the hobby market for miniature remotely piloted rotorcraft (MRPR). All these can also fall into the category of unmanned aero vehicles (UAV) and unmanned aero systems (UAS). This disclosure will use the terms remotely piloted rotorcraft, MPRM, UAS, and UAV as equivalents.

Currently, the primary payload for MRPR is small cameras. Correspondingly, the primary use for MRPR is flying small cameras around to make videos that survey objects or areas of interest—such as sporting events, volcanos, weddings, fence-lines, etc.

Another MRPR payload of interest is a radio frequency (RF) system. Elevating the antenna in an RF system above the ground provides better transmission, reception, and measurement of RF waves. In many of these RF payload applications, there is no requirement for the MRPR to fly around. Instead, the mobility required is simply that it be quick and easy to travel to a location, and then raise and hold the RF payload to desired heights. In this case, the RF payloads can be elevated without the cost of fixed infrastructure such as towers and the land to put them on, and with easy mobility, by using an MRPR.

The main problem with this solution is that the flight duration capability of today's MRPR is far too short. The severe weight restrictions on the power supply (e.g. battery) simply do not allow for long flight durations. A solution to this problem is to power the MRPR through a tether. This configuration will be called, interchangeably, a tethered UAV (TUAV), or tethered rotorcraft (TR), or tethered UAS (TUAS), or tethered MRPR (TMRPR).

Powering an aircraft through a tether creates problems due to the fact that the conductive tether interacts with local RF waves. What is needed is a technique to make the tether, RF transparent, across wide bandwidths. The interaction between the conductive tether and RF waves has several deleterious effects.

First, it makes the aircraft more detectable for two reasons. (A) It becomes very easy for a radar to detect and locate the tethered aircraft because the conductive tether reflects the radar signal. (B) It can be easy for a simple passive radio receiver to detect and locate the aircraft, due to the fact that RF emissions can come from the tether. For example, RF noise at the bottom of the tether, for example, from the power supply, or nearby power lines, or other equipment, can be re-radiated by the tether. Also, RF noise from the top of the tether, for example, from the switching power converters that convert voltages used on the tether to voltages used by the UAV and its payload, can also be re-radiated by the conductive tether. This radiated noise can allow detection and geolocation by passive receivers. The detection by radar, or a passive receiver is deleterious when concealed operations are required.

Second, the tether can interfere with the RF payload for two reasons. (A) Radiated and conducted noise from the tether can reduce the sensitivity, or blind, sensitive RF payloads like, an RF intercept receiver, or a direction-finding receiver. (B) The tether can disturb and redirect local RF waves, which impacts transmitting and receiving RF payloads. Receiving RF payloads often need to be able to measure undisturbed RF fields, or to transmit RF fields without them being absorbed or redirected by the tether. It is problematic that RF fields passing the TUAV, can be disturbed or changed by the conductive tether. For example, suppose the RF payload's function is to detect that angle-of-arrival (AoA) of a wave from a transmitter. The disturbed wave coming into the RF payload can be comprised of a sum of waves, some re-radiated by the tether, and others coming from directly from the transmitter source. In this case, the RF payload would not necessarily measure the intended AoA to the intended source-transmitter.

Similarly, a transmitting RF payload, like a jammer or a communications transmitter needs to direct its RF energy. But the conductive tether can absorb or wrongly redirect the RF energy.

Thus, it will be appreciated that an extremely light weight method for mitigating the effect of the tether on RF waves is needed.

Since RF payloads also require antennas, and these antennas can be large relative so a small drone, it will be appreciated that a method for using parts of the tether to provide an antenna function is also needed.

The present disclosure relates to tethered aircraft and mitigating the interaction of the tether on RF waves and an RF payload carried by the aircraft.

### SUMMARY

The disclosure discloses a tethered aircraft where the conductive tether is broken into two or more sections, where at least one of the sections, called isolating-sections, comprise an RF isolation means. The isolating-sections act to prevent RF current flow on the tether, and thereby reduce the interaction of the tether with RF waves and the RF payload. In other words, the two or more sections act to reduce emissions and reflections from, and conduction of RF waves along, the tether. The tether is made with one or more cable types that include coaxial, triaxial, multi-conductor cable, such as twisted pair, and shielded multi-conductor cable, such as shielded twisted pair, and double shielded multi-conductor cable which has an inner and outer shield around the multi-conductor cable.

Isolating-sections are comprised of at least one of: a flux-coupled transformer; an open-circuit stub; a magnetic choke; and a stubbed magnetic choke; all of which create an RF current stopping, high impedance, across the isolating section. The isolating-sections can be made with cable types that include coaxial, triaxial, multi-conductor cable such as twisted pair, shielded multi-conductor cable, and double shielded multi-conductor cable which has an inner and outer shield around the multi-conductor cable. Sections can be configured to serve as a part of an antenna.

The application of using sectioned tethers, as disclosed here, is useful not only for tethers that convey power, but also for tethers that serve other purposes, such as conveying information and signals.

A tether system is provided, comprising: a multi-conductor tether, including a first interval that is a first radio-frequency-isolating interval which includes at least one of: a first magnetic-choke section, a first open-stub-transmission-line section, a first open-stubbed-magnetic-choke section, or a first magnetic-flux-coupled section, and a multi-conductor cable connected to the first interval.

The multi-conductor tether may be configured to conduct power from a ground-based power source to an aircraft.

The magnetic-choke section may include a length of the multi-conductor cable that passes through or is wound around a core, to form a choke that inhibits radio frequency current from flowing through the magnetic choke-section.

The core may be a high mu core.

The core may be an air core.

The core may be a resistive or ferrite-loaded bendable material.

The open-stub-transmission-line section may include a short length of the multi-conductor cable with a first and second end, with the multi-conductor cable having an outer conductor configured as a conductive outer-shield surrounding a plurality of inner conductors, at least two of which conduct power, the outer conductor may connect to a first inner conductor selected from one of the inner conductors at the first end of the open-stub-transmission-line section, and the outer conductor may connect to nothing conductive at the second end of the open-stub-transmission-line section.

The open-stub-transmission-line section may include a short length of the multi-conductor cable with a first end and a second end, with the multi-conductor cable having an outer conductor configured as a conductive outer shield surrounding a plurality of inner conductors, at least two of which conduct power, at least one inner conductor and the outer conductor, at the first end of the open-stub-transmission-line section, may be coupled together at radio frequency, and the outer conductor may connect to nothing conductive at the second end of the open-stub section,

The coupling of the at least one inner conductor and the outer conductor may be by a direct conductive connection.

The coupling of the at least one inner conductor and the outer conductor may be by capacitive coupling.

The open-stubbed-magnetic-choke section may include one or more series-connected open-stub-transmission-line sections passing through a core or wound in a coil around core, to form a choke that inhibits radio frequency current from flowing through the open-stubbed-magnetic-choke section; and

The core is a high mu core.

The core may be an air core.

The core may be a resistive or ferrite-loaded bendable material.

The magnetic-flux-coupled section may include a flux-coupled transformer, with a primary side and a secondary side, where the primary side connects to a power conductor that conducts power through a path leading to the ground-based power source, and where the secondary side conducts power through a path leading to the voltage converter on the aircraft, and the multi-conductor tether may include a first power conductor, a second power conductor, and the second power conductor is connected to a primary side of the flux-coupled transformer.

The multi-conductor tether may be configured to conduct power from a ground-based power source to an aircraft.

The first power conductor may be located on an aircraft side of the flux-coupled transformer, and the second power conductor may be located on a ground-based-power-source side of the flux coupled transformer.

An end of a radio-frequency-isolating section may be located less than 1 wavelength from the aircraft, and the wavelength may correspond to a frequency where a radar should not detect the tether or where radio frequency equipment on or near the aircraft should operate without impact from the tether.

The magnetic-choke section or the open-stubbed-magnetic-choke section may be wound on a core material with mu greater than 2.

The magnetic-choke section or the open-stubbed-magnetic-choke section may be wound on a core material with mu greater than 2, and may be shaped in one of: a block, a cylinder, a toroid, a non-toroidal shape with one or more holes through it, through which the conductors may pass, or two side-by-side toroids to form a two-hole shape.

The tether may use at least one magnetic-flux-coupled section and may be configured to provide power from a ground-based power source to an aircraft using alternating current.

At least one of the inner conductors may comprise a radio-frequency-conductor configured to conduct a radio frequency signal to an antenna, the antenna being formed by three sequential sections, a first antenna section, a radio-frequency-isolating section, and a second antenna section, wherein the radio-frequency-isolating section may have a first side passing to the first antenna section, and has a second side passing to the second antenna section, and the radio-frequency-conductor from the first side of the RF-isolating section may connect to the outer-shield of the second antenna section.

At least one of the inner conductors may comprise a radio-frequency-conductor configured to conduct a radio frequency signal to an antenna, the antenna is formed by four sequential sections: a first antenna section, a first radio-frequency-isolating section, a second antenna section, and a second radio-frequency-isolating section, wherein the radio-frequency-isolating section may have a first side passing to the first antenna section, and has a second side passing to the second antenna section, and the radio-frequency-conductor from the first side of the first radio-frequency-isolating section may connect to the outer-shield of the second antenna section.

At least one of the inner conductors may comprise a radio-frequency-conductor used to conduct a radio frequency signal to an antenna, the antenna may be formed by five sequential sections: a first radio-frequency-isolating section, a first antenna section, a second radio-frequency-isolating section, a second antenna section, and a third radio-frequency-isolating section, the second radio-frequency-isolating section may have a first side passing to the first antenna section, and has a second side passing to the second antenna section, and the radio-frequency-conductor from the first side of the second radio-frequency-isolating section may connect to the outer-shield of the second antenna section.

The tether system may further comprise a second interval that is a radio-frequency-isolating section interval which includes at least one of: a magnetic-choke section, an open-stub-transmission-line section, an open-stubbed-magnetic-choke section, or a magnetic-flux-coupled section, wherein a length of the multi-conductor cable may extend between the first and the second intervals.

A method of powering an aircraft system is provided, comprising: forming a multi-conductor tether, including a first section interval that is a radio-frequency-isolating section interval which includes at least one of: a magnetic-choke section, an open-stub-transmission-line section, an open-stubbed-magnetic-choke section, or a magnetic-flux-coupled section, and connecting a multi-conductor cable to the first section interval.

The multi-conductor tether may be configured to conduct power from a ground-based power source to an aircraft.

The method may further comprise: forming a second section interval that is a second radio-frequency-isolating section interval which includes at least one of: a second magnetic-choke section, a second open-stub-transmission-line section, a second open-stubbed-magnetic-choke section, or a second magnetic-flux-coupled section, and connecting the multi-conductor cable to the second section interval.

### BRIEF DESCRIPTION OF THE DRAWINGS

The accompanying figures, where like reference numerals refer to identical or functionally similar elements and which together with the descriptions below are incorporated in and form part of the specification, serve to further illustrate an exemplary embodiment and to explain various principles and advantages in accordance with the present disclosure.

FIGS. 1A, 1B, 1C, and 1D, show pictures of example Tethered UAVs according to disclosed embodiments;

FIG. 2A shows an end cut view of a coaxially shielded twisted pair;

FIG. 2B shows a perspective view of a shielded twisted pair with the same construction as FIG. 2A but without the insulating layer;

FIG. 2C shows a perspective view of a triaxially shielded twisted pair with the same construction as FIG. 2B but with an additional shield;

FIG. 3A shows an end cut view of a triaxial cable;

FIG. 3B shows a perspective view of a triaxial cable with the same construction as FIG. 3A;

FIG. 4A shows two sections of shielded twisted-pair connecting through a flux coupled transformer being used as a flux-coupled section;

FIG. 4B shows an embodiment similar to FIG. 4A wherein the tether is made using sections of triaxial cable which connect to each other through a flux coupled transformer;

FIGS. 5A and 5B show a tether with open-stub sections acting as open-stud-transmission-line sections, made with triaxial cable;

FIGS. 6A-6C show a series of open-stub sections using shielded twisted pair acting as open-stub-transmission-line sections;

FIGS. 7A and 7B show an alternative embodiment of FIGS. 6B and 6C;

FIGS. 8A and 8B show another exemplary construction of open-stub sections;

FIGS. 9A, 9B, 9C, and 9D show the turns going through a high mu core material, the material having a single hole;

FIG. 10 shows an example embodiment where a light weight distribution is used to eliminate interaction between the tether and an RF wave near an RF payload; and

FIG. 11 shows inclusion of an antenna in the sectioned tether.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, may be supported with various ferrite material shapes and various cable configurations, such as flat, twisted, coaxial, triaxial, etc. It is expected that one of ordinary skill, notwithstanding possibly significant effort and many design choices motivated by, for example, available time, current technology, and economic considerations, when guided by the concepts and principles disclosed herein will be readily capable of generating the required circuitry with minimal experimentation. Therefore, in the interest of brevity and minimization of any risk of obscuring the principles and concepts according to the present disclosure, further discussion of such hardware will be limited to the essentials with respect to the principles and concepts used by the exemplary embodiments.

CORE: The term “core” generally refers to the material that the wire in a transformer or inductor is wound around. The term “high mu core” refers to a material with a relative permeability (μᵣ) greater than 1, or air. High-mu core material is formulated to work best in particular frequency ranges. For example, vendors such as Fair-Rite Products Corp. and Amidon Associates, Inc. sell standard commercial off the shelf (COTS) ferrite and iron powder formulations by material numbers, such as #75 material for lower (˜HF) frequencies, #31 material for mid (˜VHF) frequencies, and #61 for higher (˜UHF) frequencies. For the purposes of this patent disclosure, the term “core” will imply a high mu core or an air core, and examples will use the above material numbers for enabling illustration purposes.

Cores can be shaped and sized to affect and give desired performance. They can be shaped as a straight or a curved rod. They can be shaped with one or more holes to allow winding one or more wires through them. They can be made with multiple pieces that fit together, such as a first piece shaped as an E, to make it easy to wind a coil of wire around the center extension of the E, and a second piece that lays across the three ends of the E such that it behaves like a two-hole core with a closed-loop magnetic path. They are typically brittle, but flexible material is also available.

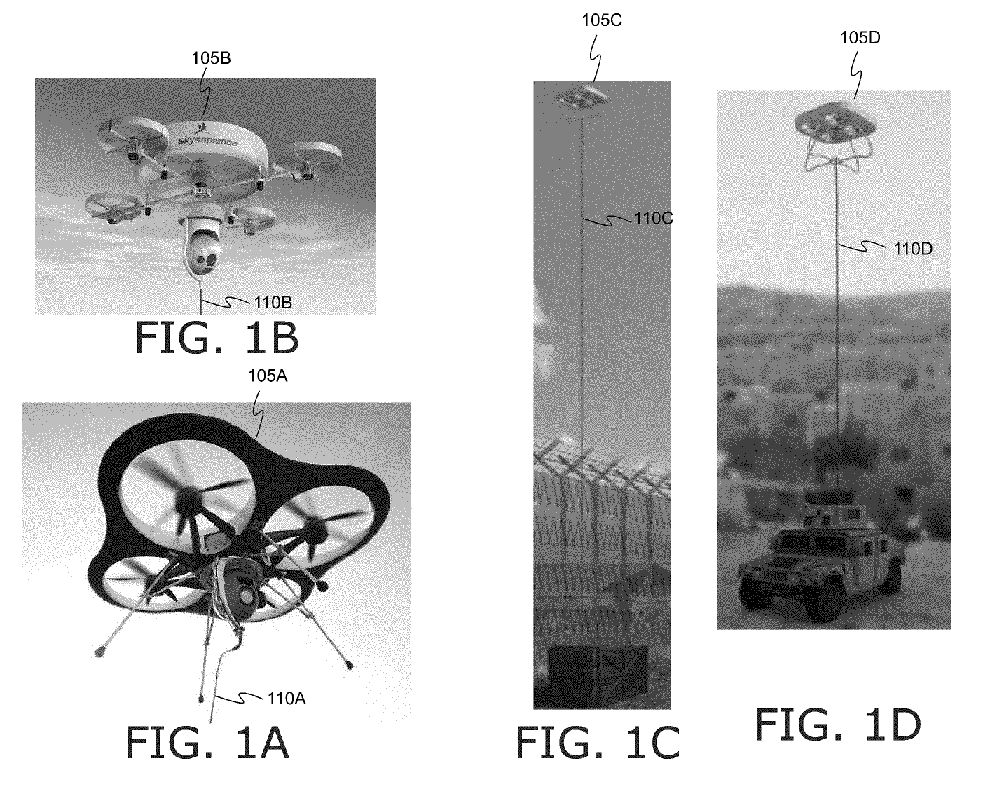

FIGS. 1A, 1B, 1C, and 1D, show pictures of example Tethered UAVs according to disclosed embodiments.

In particular, FIG. 1A shows a close-up picture of one type of TUAV 105A with a tether 110A according to disclosed embodiments.

FIG. 1B shows a close-up picture of a different type of TUAV 105B with a tether 110B according to disclosed embodiments.

FIG. 1C shows a picture of a TUAV 105C tethered by a tether 110C to a fence according to disclosed embodiments.

FIG. 1D shows a picture of a TUAV 105D tethered by a tether 110D to an armored vehicle according to disclosed embodiments.

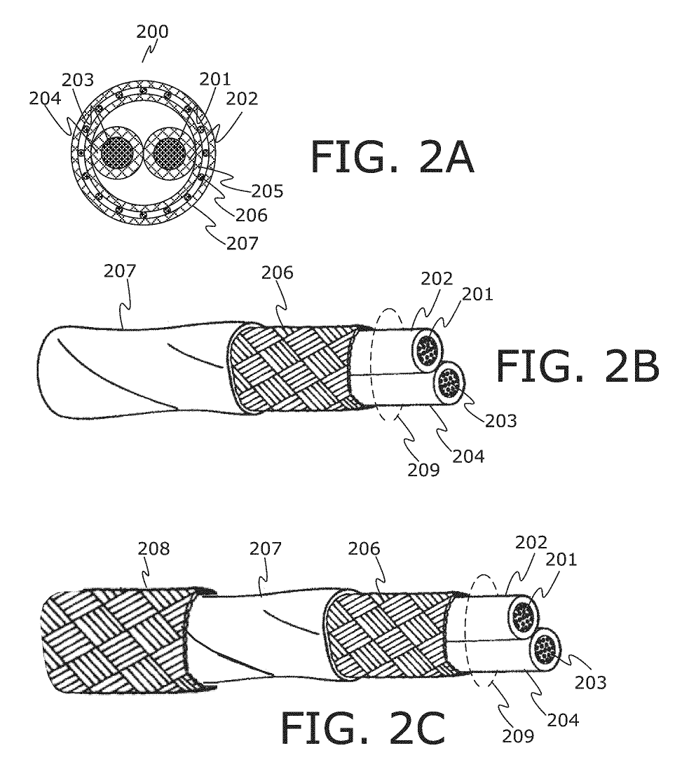

FIG. 2A shows an end cut view of a coaxially shielded twisted pair. The twisted pair includes a first conductor 201 wrapped with a first insulator 202, and a second conductor 203 wrapped with a second insulator 204. The above twisted pair is further wrapped with a shield 206, followed by the outer jacket insulation 207, to form a coaxially shielded twisted pair. Sometime, the cable construction also includes another insulation layer 205.

FIG. 2B shows a perspective view of the above shielded twisted pair with the same construction as FIG. 2A but without the insulating layer 205.

FIG. 2C shows a perspective view of a triaxially shielded twisted pair with the same construction as FIG. 2B but with an additional shield 208.

While FIGS. 2A-2C show one or two shields around two conductors, this same construction can be used with one or two shields around a multi-conductor bundle of wires, 209, that can include multiple wire types, including coaxial and triaxial types.

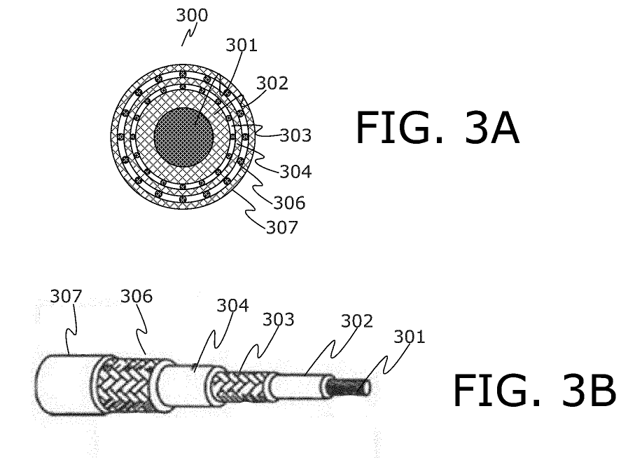

FIG. 3A shows an end cut view of a triaxial cable 300. The triaxial cable includes a center conductor 301, which is wrapped with a first insulator 302, which is further wrapped with an inner shield 303, which is further wrapped with a second insulator 304, which is further wrapped with an outer shield 306, which is further wrapped with an outer jacket 307.

FIG. 3B shows a perspective view of a triaxial cable with the same construction as FIG. 3A.

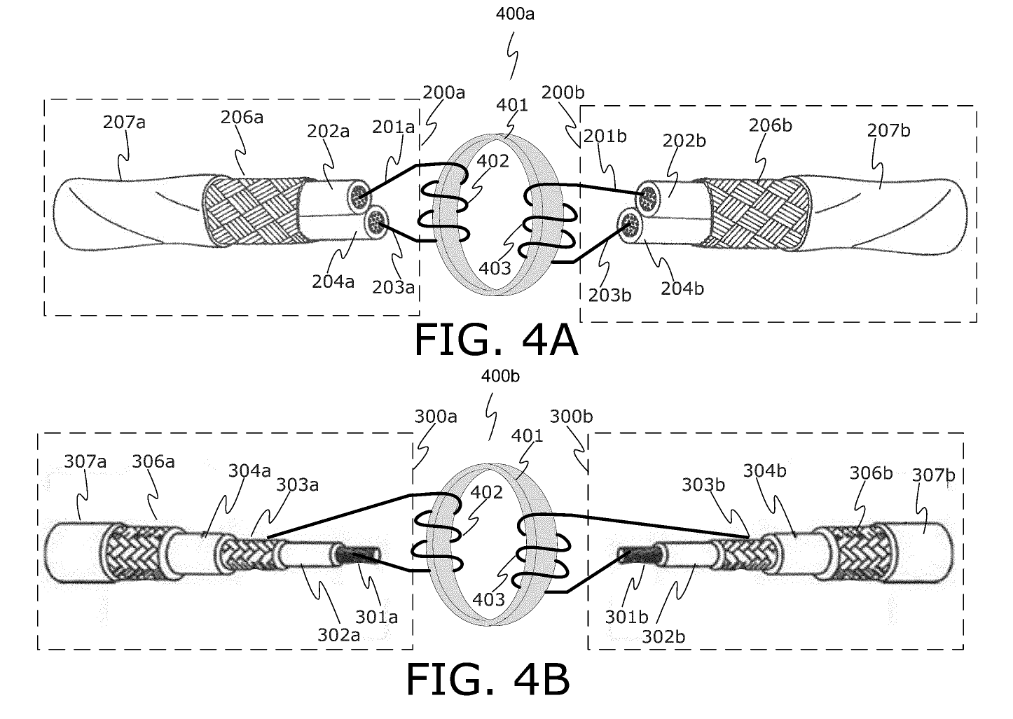

FIG. 4A shows two sections of shielded twisted-pair connecting through a flux coupled transformer being used as a flux-coupled section. The flux-coupled transformer includes a core 401, a primary winding 402, and a secondary winding 403.

FIG. 4A shows an embodiment in which the tether is made using sections of shielded twisted-pair connecting through a flux coupled transformer 400a, which is shown made with a toroidal core. This configuration could also be made with unshielded twisted pair. Primary 402 is connected to a shielded twisted pair 200a from a section of the tether. Secondary 403 is connected to a shielded twisted pair 200b from an adjacent section of the tether. The shielded twisted pair sections 200a and 200b are built as shown in FIG. 2b, with like numerals.

FIG. 4B shows an embodiment similar to FIG. 4A wherein the tether is made using sections of triaxial cable which connect to each other through a flux coupled transformer 400b. Standard coaxial cable (i.e. without the outer shield 306 and the outer jacket 307, and where the jacket would be 304) could also be used in this configuration. The primary 402 is connected to a triaxial cable 300a from a section of the tether. The secondary 403 is connected to a triaxial cable 300b from an adjacent section of the tether. The triaxial cable sections 300a and 300b are built as shown in FIG. 3b, with like numerals.

The flux coupled transformer shown in FIGS. 4A and 4B could also be configured to connect to different wire configurations on its two sides. For example, it could connect to a twisted pair on one side (i.e. as in FIG. 4A), and to coaxial cable on the other side (i.e. as in FIG. 4B).

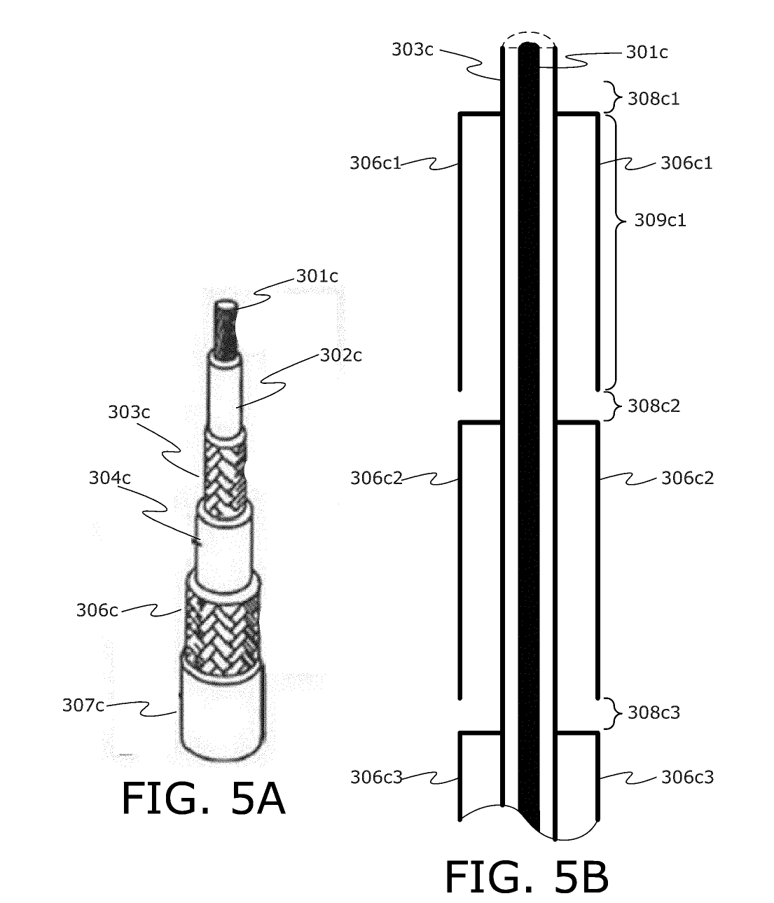

FIGS. 5A and 5B show a tether with open-stub sections acting as open-stud-transmission-line sections, made with triaxial cable, where FIG. 5A shows a 3D view of the triaxial cable, and where FIG. 5B shows a drawing that is a cross-sectional cut to show the center cross-section of the cable showing a little more than 2 open-stub sections.

OPEN STUB: An open-stub is made from a length cable with an inner conductor and an outer conductor, where the inner and outer conductors are shorted at one end, and at the other end, the outer conductor simply stops and does not connect to anything, creating an open. In FIGS. 5A and 5B, the inner conductor of an open-stub section is the inner shield 303c of the triaxial cable, while the outer conductor of the open-stub section is made with a section of the outer-shield 306c of the triaxial cable. Each open-stub: (a) starts on one side of a gap in the outer-shield, where the outer shield and inner shield connect together; and (b) ends at a different gap in the outer shield, where the outer shield simply stops and does not connect to anything. The shorted end of the open-stub is formed by a direct connection, or a short, between the outer shield and the inner shield, at one side of the gap.

In FIG. 5B, the first conductor of the tether is the center conductor of the triaxial cable 301c. The second conductor of the tether is the inner shield of the triaxial cable 303c. The upper most open-stub in FIG. 5B starts with gap 308c1, a gap in the outer shield 306c of the triaxial cable. The shorted end of the open-stub is formed by connecting out outer shield 306c1 to inner shield 303c at the bottom of gap 308c1, and by making the other end of the open-stub an “open” by letting the outer shield 306c1 simply stop—which happens at the top of gap 308c2. The stub-length 309c1 of this open-stub is the length between the bottom of outer-shield gap 308c1 to the top of outer-shield gap 308c2.

Any RF current on the inner shield 303c whose wavelength is in the neighborhood of an odd number of ¼ wavelengths (i.e. ¼, ¾, 5/4, etc.) will be impeded because the open-stub will appear nearly like an open circuit (i.e. a high series impedance) at these resonant wavelengths.

Wavelengths longer that ¼ wavelength (i.e. lower in frequency) can also be impeded by connecting a number of these stubs in series. The series of stubs works at lower frequencies because the series impedance that a short stub has at lower frequencies will still add up over the multiple stubs to obstruct current flow.

FIG. 5B illustrates a series of open-stubs. In FIG. 5B, the upper most stub is followed by another open-stub is formed by the connection of outer shield 306c2 at the bottom end of gap 308c2, and the open at the end of outer shield 306c2 at the top of gap 308c3. The beginning of another open-stub is shown at the bottom end of gap 308c3, at the connection of the outer shield 306c3 to the inner shield 303c. In some applications, the stub lengths are made identical and made ¼ wavelength at the highest frequency of interest. In other applications, they are made different lengths to optimize the frequency bands of interest to that application.

This construction of open-stub sections can be used over the entire length of the tether, or over specific intervals of the tether that are exposed to stronger RF fields, or fields which are important not to disturb. For example, in some applications, to reduce weight, it is only used in an interval of the tether near the RF-system payload. In other applications, to reduce the wideband radar signature of the tether, it is used over the entire length, or nearly the entire length of the tether.

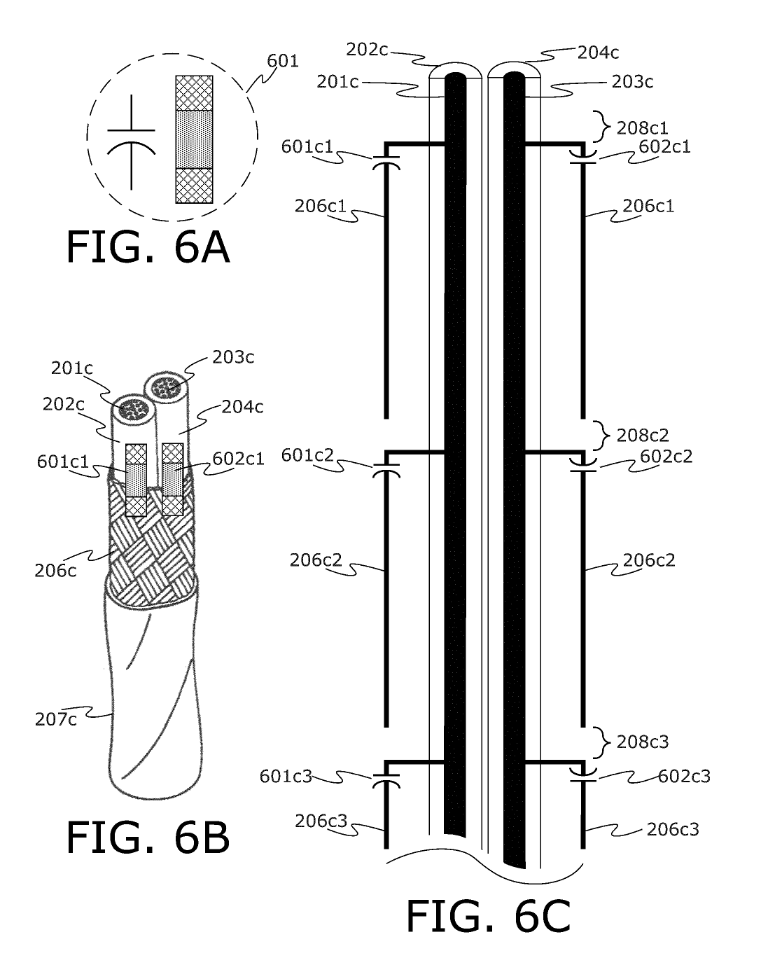

FIGS. 6A-6C are similar to FIGS. 5A and 5B and show a series of open-stub sections using shielded twisted pair acting as open-stub-transmission-line sections, as opposed to FIGS. 5A and 5B which show open-stub sections using triaxial cable.

FIG. 6A shows a schematic symbol and drawing for a capacitor, 601, that will be used in the drawings to represent capacitors.

FIG. 6B shows an example placement of capacitors 601c1 and 602c1 on an open-stub section. Given this example illustration, other placements, and other variations using multiple parallel capacitors to improve the capacitive shunt characteristics would be obvious to one skilled in the art of RF circuits. If the shield was around a multi-conductor bundle, the other conductors could be bypassed similarly.

FIG. 6C follows similarly from FIG. 5B. In this case, both leads of the twisted pair, 201c and 203c, represent the inner conductor of the stub. Shield 206c of the shielded twisted pair represents the outer conductor of the stub. The shorted end of the open-stub is shorted by one or more capacitors. FIG. 6C shows, for the upper most stub, each lead of the twisted pair, 201b and 203b, shorted to the shield 206c1 via a capacitor, 601c1 and 602c1 respectively. Like FIG. 5B, the open end of the stub is simply where the shield stops, creating an open—which in this case is at the top of gap 208c2.

FIG. 6C illustrates a series of open-stubs. In FIG. 6C, the upper most stub is followed by another open-stub that is formed by the RF-short connection of outer shield 206c2 at the bottom end of gap 208c2, through capacitors 601c2 and 602c2, to the twisted-pair leads 201c and 203c respectively, and the open at the end of the stub where shield 206c2 stops, which is at the top of gap 208c3. The beginning of another open-stub is shown at the bottom end of gap 208c3, at the connection of the outer shield 206c3 through capacitors 601c3 and 602c3, to the twisted-pair leads 201c and 203c respectively. The RF-shorts made by the capacitors allow the twisted pair configuration of FIGS. 6A-6C to operate and have similar RF isolation properties as the triaxial configuration of FIGS. 5A and 5B. This shielded-twisted-pair embodiment can be preferred in applications that benefit from the shielded sections being very well balanced to signals on the twisted pair and where less capacitance between the twisted pair is desired. If the outer shield does not need to be DC isolated from one of the inner leads 201c and 203c, then either capacitor 601c or capacitor 602c could be eliminated and replace with a short circuit.

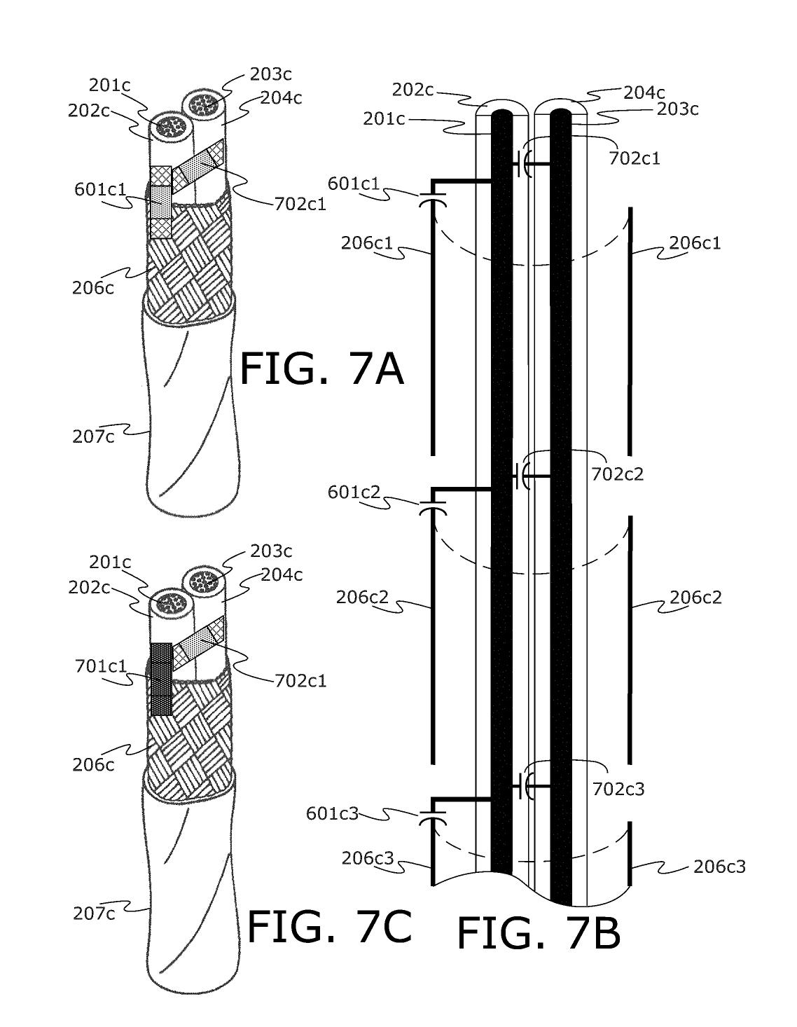

FIGS. 7A and 7B show an alternative embodiment of FIGS. 6B and 6C, respectively, but where capacitors 602c1, 602c2, and 602c3 are replaced by 702c1, 702c2, and 702c3, respectively. In this case, 702c1, 702c2, and 702c3, create a low impedance RF path (nominally, an RF-short) between the twisted pair leads 201b and 203b. This embodiment can be used in applications that: (a) have low frequency differential signals on the twisted pair and would benefit from having a better short between the twisted-pair-lines at these low frequencies; (b) have capacitor size restrictions; and (c) desire no DC connection to the shield. If the shield was around a multi-conductor bundle, its wires could be handled similarly.

FIG. 7C is identical to FIG. 7A except it depicts an alternate embodiment which eliminates the 601 capacitors (601c1, 601c2, 601c3 in FIG. 7B and 601c1 in FIG. 7A) and replaces them with a short, illustrated with 701c1 in FIG. 7C, which connects the shield to the 201c wire in the twisted-pair. This embodiment might be preferred due to the smaller number of components, and because it works especially well when the 201c conductor is connected to a common ground on either side of the tether.

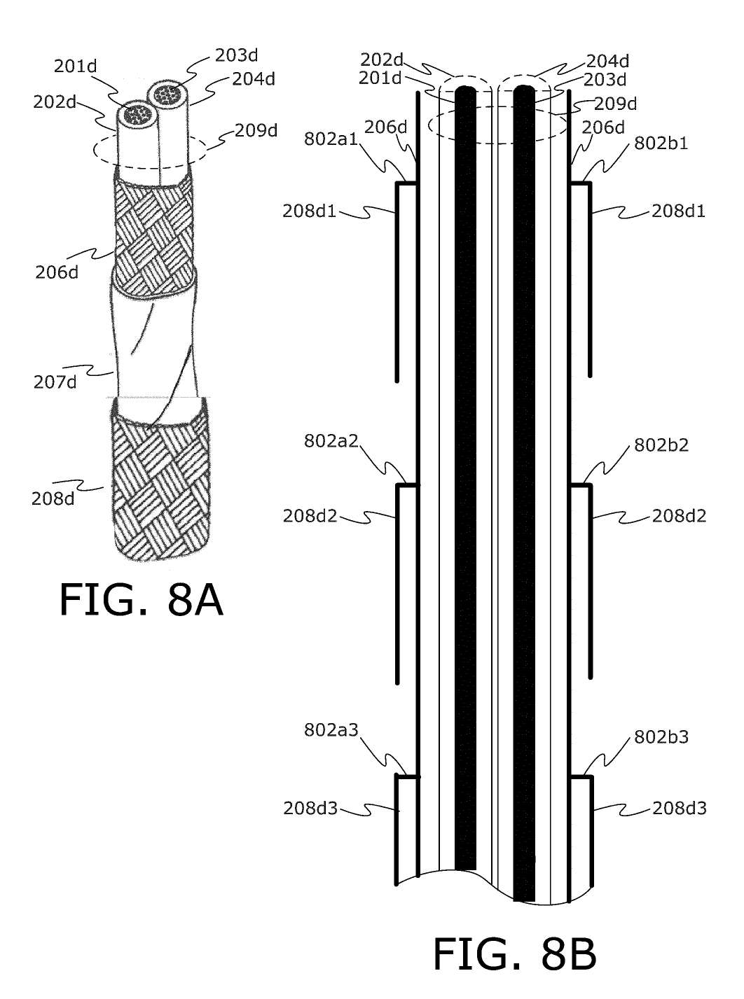

FIGS. 8A and 8B show another exemplary construction of open-stub sections, similar to the previous illustrations in FIGS. 5A and 5B, 6A-6C, and 7A-7C, but shows a construction that eliminates the capacitors of FIGS. 6A-6C and FIGS. 7A-7C, making it easier to use with a bundle of cables 209d, which can be a bundle comprised of any mix of cables, including one or more single conductors as illustrated with 201d and 203d, and multi-conductor cables, including coaxial and triaxial types.

FIG. 8A is a 3D perspective illustration of the cable construction, with wire bundle 801 surrounded by an inner shield 206d, which is surrounded by an outer shield 208d. It repeats FIG. 2C so it can be seen immediately next to FIG. 8B.

FIG. 8B is a section-cut view showing how the wire bundle 801 is shielded by the inner shield 206d. For the purposes of the open stub, the inner shield 206d serves as the “center conductor” of a coaxial cable which has as its shield, the outer shield 208d. FIG. 8B shows 2 full stubs, the 208d1 section which is shorted to the inner shield 206d with 802a1 and 802b1 connections, and the 208d2 section which is shorted to the inner shield 206d with 802a2 and 802b2 connections, plus the beginning of a third with the 208d3 section which is shorted to the inner shield 206d with 802a3 and 802b3 connections. Ideally, the short between the inner and outer shield would go the entire circumference of these shields.

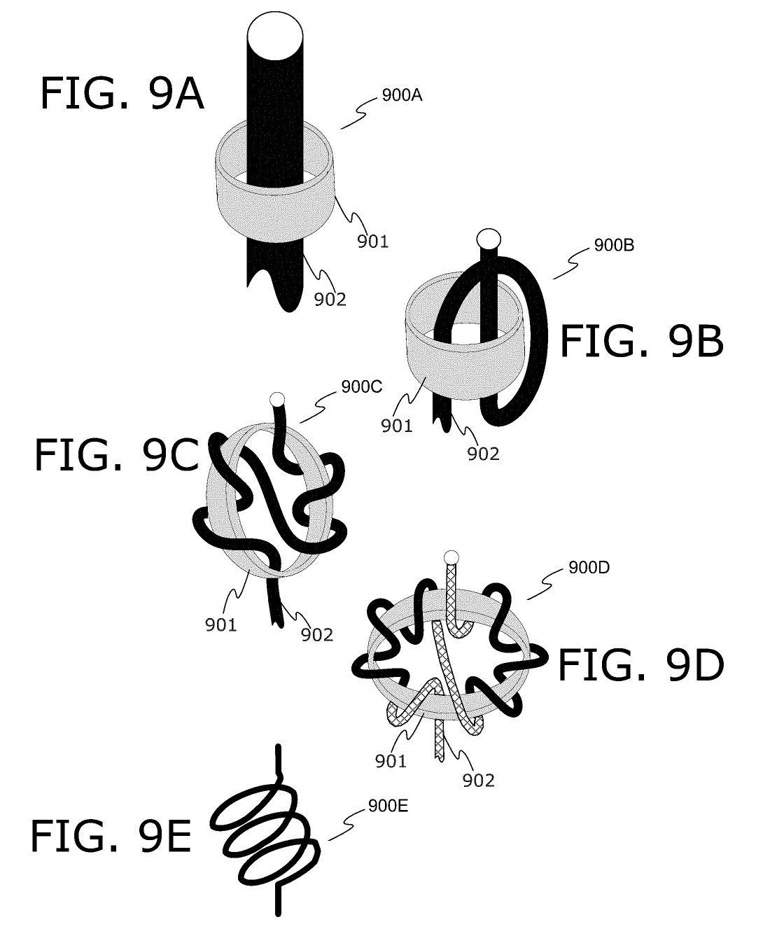

FIGS. 9A-9E show the multi-conductor tether cable, such as the cable configurations of FIGS. 2A-2C, 3A and 3B, 5A and 5B, 6A-6C, 7A-7C, and 8A and 8B, depicted as 902, being wound to make a choke acting as a magnetic choke section. FIGS. 9A, 9B, 9C, and 9D show the turns going through a high mu core material 901, the material having a single hole. FIG. 9A shows a single turn winding 900A, since the cable passes through the core once. FIG. 9B shows a two-turn winding 900B since the cable passes through the core two times. FIG. 9C shows a five-turn winding 900C. FIG. 9D shows a nine-turn winding 900D, and also shows, by way of the series of five hatched versus non-hatched wire sections, a series of five open-stub sections. The hatching and solid sections of cable in FIG. 9D are meant to convey a series of open stub transmission line sections, where the first turns, shown with hatching, represent an open stub transmission line section such as 306c1 in FIG. 5B or 206c1 in FIG. 6C and FIG. 7B, the next turns are shown with solid black, where the solid black represents the next open stub transmission line section such as 306c2 in FIG. 5B or 206c2 in FIG. 6C and FIG. 7B, the next turns are shown with hatching, where the hatching represents the next open stub transmission line section such as 306c3 in FIG. 5B or 206c3 in FIG. 6C and FIG. 7B, the next turns black and the next hatched and so forth, to illustrate a series open stub transmission line sections. As such, FIG. 9D highlights the use of a combination of windings and stubs, where windings comprised of one or more stubs to impede current flow on the outside of the cable, and forms an open-stubbed-magnetic-choke section. FIG. 9E shows an air-core choke 900E which can be used at higher frequencies, and to save weight. All of the embodiments of FIGS. 9A-9E could use a cable configured with stubs and thereby be open-stubbed-magnetic-choke sections, where the cable includes configurations illustrated in FIGS. 5A and 5B, 6A-6C, 7A-7C, and 8A and 8B. Of note, the sectioned tether cable can be implemented with a combination of radio-frequency-isolating sections that includes magnetic-choke sections, open-stub-transmission-line sections, open-stubbed-magnetic-choke sections, and magnetic-flux-coupled section, such that open-stub-transmission-line sub-sections can exist within the windings on a choke section (as particularly illustrated in FIG. 9D), and/or, on the cable between or adjacent to a other radio-frequency-isolating sections.

In each embodiment of FIGS. 9A-9E, the winding construction “chokes off” RF current because the winding on the core creates a high impedance between the cable coming in on one side of the core, and the cable going out on the other side of the core. That being the case, we will refer to these constructions as a choke. The cable can also be wound through a multi-hole core. While FIGS. 9A-9E show examples with different numbers of turns, any number of turns may be used. The number used is governed by the frequencies of interest and the mu and size and shape of the core material.

Instead of winding the turns continuously around the core such that the input and output are side-by-side, FIGS. 9C and 9D show a winding construction that puts the input and output ends on opposite sides. Use of this winding construction creates less capacitive coupling between the input and output sides of the cable. As a result, this winding construction chokes off RF current at higher frequencies better and thereby improves the RF isolation between the adjacent sections of the tether.

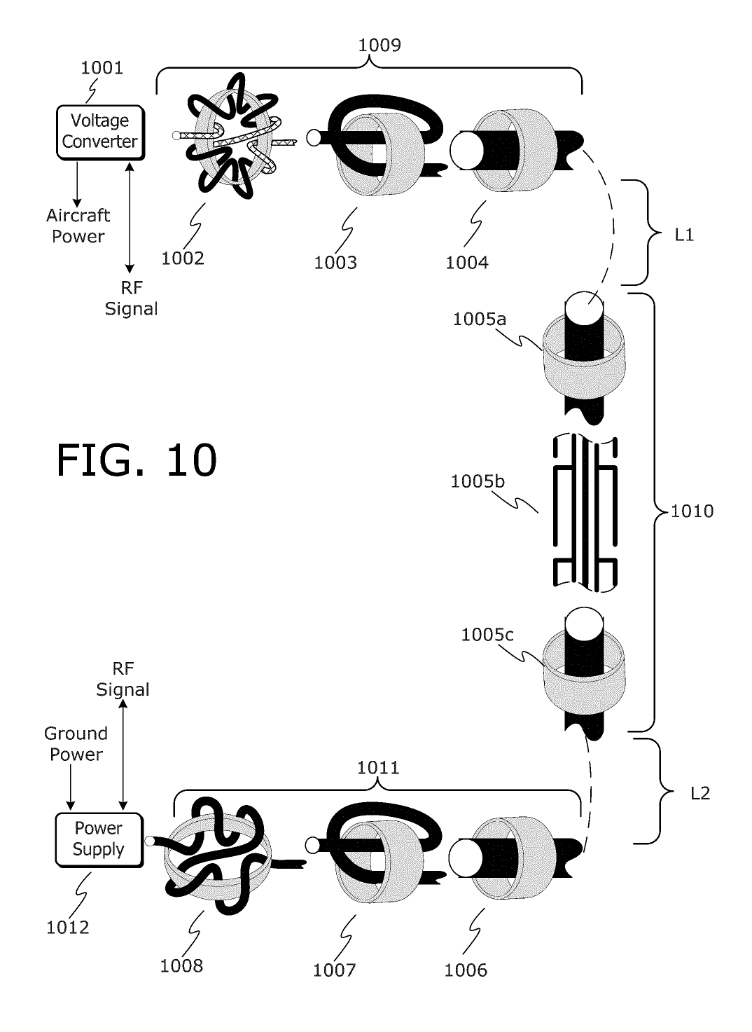

FIG. 10 shows an example embodiment where a light weight distribution is used to eliminate interaction between the tether and an RF wave near an RF payload. Ground based power supply 1012 supplies power to the TUAV, and may also include a Bias-T to couple an RF signal onto the tether so that an RF signal can be sent from the ground to the TUAV, or from the TUAV to the ground. Voltage converter 1001 receives power from the power supply 1012, via the tether, and may also include a bias-T allow both DC power, and AC signals like RF, to both pass through the tether. Because both DC power and an RF signal can be passed through the tether, any statement about conducting power should also be construed to imply conducting the RF signal also, unless specifically stated otherwise.

The first tether interval 1009 is connected at one end to a voltage converter 1001 on the aircraft, and at the other end to a second tether interval 1010. It is a short interval located near the voltage converter 1001. The second tether interval 1010 is connected at one end to the first tether interval 1009, and at the other end to a third tether interval 1011. The third tether interval 1011 is connected at one end to the second tether interval 1010, and at the other end to the ground based power supply 1012. It is a short interval located near the power supply 1012. Each tether interval can be comprised of any combination of RF isolating sections, including magnetic-choke sections, an open-stub-transmission-line sections, an open-stubbed-magnetic-choke sections, or a magnetic-flux-coupled sections. The combination of different section constructions create a very wide bandwidth RF “open” over the entirety of the tether, and prevent RF current from flowing in the conductive tether.

In the FIG. 10 example case, a first tether interval 1009, at the end of the tether nearest the aircraft, is made to make the tether appear to a wideband RF current as if it was an open circuit in a small space near the aircrafts voltage converter 1001. In other words, to an RF wave hitting the tether, it makes the tether appear as if it simply stopped before reaching voltage converter 1001. The second tether interval 1010, conducts power mostly vertically, between the aircraft and the ground. It is made to minimize re-radiation RF signals, and may potentially be made to form an antenna. The third tether interval 1011, at the end of the tether nearest the ground based power supply 1012, is made to make the tether appear to a wideband RF current as if it was an open circuit in a small space near the power supply 1012. In other words, to an RF wave hitting the tether, it makes the tether appear as if it simply stopped before reaching power supply 1012.

The first tether interval 1009 is shown with an open-stubbed-magnetic-choke section 1002, and two magnetic-choke sections 1003 and 1004. By way of example, choke 1002 could be 5 turns on #75 ferrite material to cover lower frequencies like the HF band, choke 1003 could be 3-turns on #31 ferrite material to cover mid frequencies like the VHF band, and choke 1004 could be 1 turn on #61 material to cover higher frequencies, like the UHF band. The entire tether could be comprised of a series of open-stub transmission line sections, so that any magnetic choke section, would become an open-stubbed-magnetic-choke section, as illustrated in FIG. 9D and choke 1002. The stubs would cover the highest frequencies, such as above the UHF band.

The second tether interval 1010 contains magnetic choke sections 1005a and 1005c, and a series of open-stub-transmission-line sections 1005b. By using open-stub-transmission-line sections over the long vertical portion of the tether, the weight of the tether due to the heavy ferrite material used in hi mu cores is minimized. The accumulation of impedance across the multiple open-stub-transmission-line sections aid in reducing the number of cores required by any application. The lower the frequency (i.e. the longer the wavelength), the more distance can be placed between chokes, and the more distance there is for the impedance to accumulate on the greater number of open-stub-transmission-line sections.

The third tether interval 1011, at the end of the tether nearest the ground power supply 1012, is made to make the tether appear to a wideband RF current as if it was an open circuit, and do it over a very short distance. In other words, to an RF wave hitting the tether, it makes the tether appear as if it simply stopped prior to reaching the power supply 1012. That being the case, any RF current picked up by the tether cannot flow to the power supply 1012. The third tether interval 1011 can comprise a any combination of RF isolation section configurations. By way of example, the third tether interval 1011 includes three magnetic choke sections 1006, 1007, 1008. In this exemplary embodiment, choke 1006 could be 1 turn on #61 material to cover higher frequencies, like the UHF band, choke 1007 could be 3-turns on #31 ferrite material to cover mid frequencies like the VHF band, and choke 1008 could be 5 turns on #75 ferrite material to cover lower frequencies like the HF band. If the cable going through these cores was comprised of open-stub transmission line sub-sections, these chokes would become open-stubbed magnetic choke sections, where the stubs would cover the highest frequencies, such as above the UHF band. The combination would create a very wide bandwidth RF “open” to any RF signal picked up by the tether and prevent RF current from flowing to power supply 1012.

The second tether interval 1010 in FIG. 10 might be hundreds of feet long. In extremely sensitive applications, this second tether interval may need to have a sequence of cores spaced and sequenced according to the application's frequency coverage. For example, if there were cores H, M, and L, for high, medium, and low frequency, the cores might be in a repeating sequence HHHMHHHMHHHMHHHL, to best serve the application's specific frequency range of interest. In some applications, the low-to-high frequency ordering in the chokes is the preferred embodiment. In other applications, only the highest frequency chokes are needed since their closer spacing allows their impedance to accumulate over the long wavelength of lower frequencies. In other applications, open-stub transmission line sections alone can be sufficient, saving the weight of the heavy high mu core material. Payloads aimed at different functions, and applications with different objectives can require other spacings between chokes and other orderings of core material to optimize the different performance metrics in different frequency bands of interest.

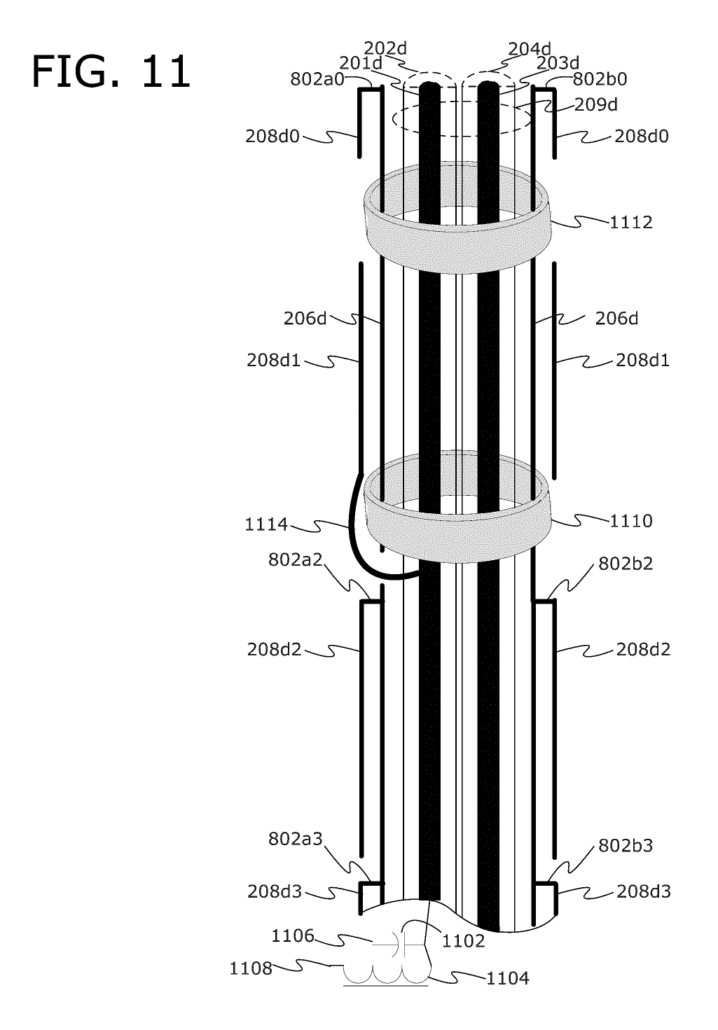

FIG. 11 shows inclusion of an antenna in the sectioned tether. It follows from FIGS. 8A and 8B, but that configures the illustrated sections to show inclusion of an antenna. The intent of the illustration is to highlight the piece of the tether with the antenna. As such, the actual tether typically extends above and below the page and has additional sections. The illustrated antenna is a simple dipole, where one side of the center feed of the dipole is at jumper 1114, which feeds the upper half of the dipole, formed by the 208d1 outer shield section. The other side of the center feed is at the top of the open stub at 802a2 and 802b2, which feeds the lower half of the dipole, formed by the 208d2 outer shield section. A first core 1110 allows a feed voltage across input and output sides of the core.

There are multiple configurations for this core and the feed point. The optimum configuration depends on the wire sizes and frequency band of interest. For example, while as shown, the inner shield goes through the core, it can also be configured such that only the multi-conductor bundle 209 goes through the core. Similarly, while as shown, the inner conductor is continuous across the feed, the inner shield can also be configured to be broken at the feed. Another alternative is, with the inner shield broken, the first core 1110 can be removed and the upper feed point can be configured so that jumper 1114 connects to both the inner and outer shield at the bottom of the 208d1 section that forms the top half of the dipole. This configuration has the inner and outer shield connections of the upper half of the dipole being a mirror image of the lower half of the dipole. Current at the upper end of the dipole is halted by a second core 1112, as well as the isolating sections above core 1112 that may exist above the top of the page. Current at the lower end of the dipole is halted by the open-stub just above 802a3 and 802b3. The gap above 802a3 and 802b3 could be augmented by a core that would be a mirror of the second core 1112. Similarly, the second core 1112 could be removed and current could be halted by the 208d0 open-stub. The choice on using or not using these cores depends on the wire sizes and frequencies, and bandwidths of interest. Based on this description, an engineer skilled in the art would be able to optimize the configuration, and use similar sections to extend beyond a dipole and similarly drive an array of antennas.

RF and DC are typically connected into and out of the tether at the ends using a bias-T. A bias-T is simply an inductor 1004 and capacitor 1002. In this case, RF is connected to the antenna in the tether at a first point 1106 connected to the capacitor 1102, and DC is sourced or taken at a second point 1108 connected to the inductor 1104.

Given the teachings of these drawings, one skilled in the art of RF design should be able to optimize an embodiment for their specific application.

The core material 901 in FIG. 9A, the magnetic choke sections 1002, 1003, 1004, 1006, 1007, and 1008 and the open-stub-transmission-line sections 1005a, 1005b, and 1005c in FIG. 10, and the first and second cores 1110 and 1112 in FIG. 11 can be resistive or ferrite-loaded flexible or bendable or foam-like material such as a 12×24 panel of 3G shielding part number SB032-020-02 that is cut to fit. The coaxial cable can, for example, be sandwiched between the flexible sheet material or the flexible sheet and can be cut so that it wraps around the cable. In either case, the bendable material can be held in place with the adhesive backing on 3G part number SB032-0200-02-A or a wrapping such as heat shrink tubing, or any other sheathing that would hold the material against the cable.

The disclosure describes a tethered aircraft where the conductive tether is broken into two or more sections, where at least one section comprises an RF isolation means. As illustrated in FIGS. 2A, 2B, 3A, and 3B (and described above), standard twisted pair, shielded twisted pair, coaxial cable, and triaxial cable are all possible cable types for the sectioned tether. The choice of using one or more of these in different cable types in different intervals of the tether is governed the needs of a payload application, such as the payload's need to have an antenna in the tether, the payload's sensitivity and frequency coverage, and the application's need to be undetectable by radar and radio listening equipment. Sections that include an RF isolation means reduce unwanted RF emissions and RF reflections from the tether, reduce unwanted conduction of RF waves along the tether, and allow antenna elements to be placed along the tether. The RF isolation means include one or more of (a) flux-coupled transformer, or magnetic-flux-coupled section as illustrated in FIGS. 4A and 4B, and described above, (b) open-circuit stubs, or open-stub-transmission-line sections (sometimes referred to as simply open-stub sections) as described above and illustrated in FIGS. 5A and 5B, 6A-6C, 7A-7C, 8A and 8B, and 11, (c) magnetic-choke sections comprised of windings as illustrated in FIGS. 9A-9E (and described above), to create a high impedance across the winding at RF frequencies, and (d) open-stubbed-magnetic-choke sections comprised of magnetic chokes with windings comprised of one or more open-stub sections, such as is depicted in FIG. 9D. At the lowest frequencies, the impedance from multiple sections accumulates to prevent impactful RF current from flowing. An example multi-section tether is illustrated in FIG. 10 and is described above. Using sectioned tethers as disclosed, is beneficial not only for tethers that convey power, but also for tethers that serve other purposes, such as conveying information and signals. The selection of spacing between sections and selection of the type of sections is made so as to appropriately balance the advantages of improving the isolation or improving the performance of an antenna, with the disadvantages such as adding weight, according to the needs of a given application and the frequency ranges of interest.

In one embodiment, the signal or power is coupled into an adjacent section through a flux coupled transformer. FIG. 4A shows an embodiment in which the tether is made using sections of shielded twisted-pair connecting through a flux coupled transformer, which is shown made with a toroidal core. FIG. 4B shows a similar embodiment except the tether is made using sections of triaxial cable. Standard coaxial cable could also be used in this configuration.

In another embodiment, each section is isolated from its neighboring section at RF frequencies by winding the tether to make a choke. FIGS. 9A-9E show exemplary configurations, where FIG. 9A shows a single turn, FIG. 9B shows two turns, FIG. 9C shows five turns, FIG. 9D shows 9 turns (FIGS. 9A through 9D being on toroidal cores), and FIG. 9E shows 3.25 turns on an air core. These embodiments are exemplary only. Different applications can use a different number of turns and different core materials beyond what is shown in FIGS. 9A-9E. The number of turns and the magnetic properties, size, and shape of the core are optimized based on the desired frequency range of operation and tradeoffs with weight. Twisted pair with and without a shield, standard coaxial cable, and triaxial cable may also be used in this embodiment. Cable comprised of one or more open-stub sections, as shown in FIGS. 5A and 5B, 6A-6C, 7A-7C, 8A and 8B, 9D, and 11 may also be used.

In another class of embodiments, cable sections are isolated from one another at RF frequencies by creating a transmission line configuration that forms an open-stub—an open-stub being a section of transmission line that is shorted at one end, and open at the other end. At electrical lengths of n*λ/4, where n is odd, the stub looks like an open circuit. At electrical lengths shorter than ¼ wavelength, the stub looks like an inductor, with a series impedance that is going up with frequency. This class of embodiments includes coaxial versions and several twisted pair versions. These versions are illustrated in FIGS. 5A and 5B, 6A-6C, 7A-7C, 8A and 8B, 9D, and 11.

In another embodiment, a combination of isolation circuits is used. For example, the entire tether can be broken into one or more first section types that are stubs, making a sectioned tether, and further dividing this sectioned tether into one or more secondary sections, where each secondary section is isolated from its neighbor by winding the sectioned tether around or through a core, thereby further isolating sections from each other. This construction allows the higher frequencies to be isolated by one means, such as the transmission line sections, and lower frequencies to be isolated by a different means, such as the inductance induced in the turns around or through the core. FIG. 9D illustrates one embodiment of this combination by showing, with hatched versus non-hatched wires, 5 stub sections wound on a 9-turn choke.

In one embodiment, the system uses a tethered aircraft where power is provided to the aircraft through the tether, and at a location less than 1 wavelength from the aircraft, all the conductors in the tether go around or through a first core one or more times; wherein the wavelength corresponds to a desired frequency where an RF payload should operate, or where a radar should not detect the tether; and wherein the core is a material with mu greater than 2, shaped as a block or with a cylindrical shape, and may have one or more holes, through which the conductors may pass, such as a toroidal shape. For example, the conductors could go around additional ferrite material one or more times, or through additional multi-hole ferrite material one or more times, or through a single hole toroidal shaped ferrite material one or more times.

In an embodiment that can tolerate more weight, all the conductors in the tether go through or around additional cores one or more times, at additional locations with less than 1 wavelength spacing between adjacent cores starting from the first ferrite material. For example, at each additional location, the conductors could go around additional ferrite material one or more times, or through additional multi-hole ferrite material one or more times, or through a single hole toroidal shaped ferrite material one or more times.

In an embodiment that can tolerate more weight, all the conductors in the tether, at some additional locations with less than 1 wavelength spacing between adjacent ferrite material starting from the first ferrite material, go through or around additional ferrite material one or more times.

In another embodiment, the system can include a TUAV where power is provided to the UAV through the tether with alternating current (AC), and at a location less than 1 wavelength from the rotorcraft, the power conductors in the tether are cut so that the tether's power conductors that go to the payload side are connected to the secondary turns of a first flux coupled transformer, and the tether's power conductors that go to the ground station side are connected to the primary turns of the first flux coupled transformer; wherein the said wavelength corresponds to a desired frequency where an RF payload should operate, or where a radar should not sense the tether; and, wherein the flux coupled transformer is comprised of primary turns and secondary turns on or through a ferrite material.

In one embodiment, the transformer's primary turns and secondary turns are separated to reduce the capacitive coupling between them.

In another embodiment, the system includes a TUAV where power is provided to the aircraft through the tether with AC, and, at one or more additional locations with less than 1 wavelength between adjacent transformers, starting from the first flux coupled transformer, the power conductors are cut so that the tether's power conductors that go to the payload side are connected to the secondary turns of an additional coupled transformer, and the tether's power conductors that go to the ground station side are connected to the primary turns of the additional flux coupled transformer; wherein the wavelength corresponds to a desired frequency where an RF payload should operate, or where a radar should not sense the tether; and, wherein each additional flux coupled transformer includes primary turns and secondary turns on or through a ferrite or air core.

In another embodiment, the power conductors in the tether are formed from tri-axial cable, where one side of the power is conducted via the center conductor, the other side of the power is conducted via the first shield, closest to the center conductor, and the second shield is cut into sequential section-pairs, where each section-pair is comprised of a gap section where the second shield is removed, and a section nominally ¼ wavelength or less long, with one end is shorted to the first shield, and with the other end connecting to nothing; wherein the said wavelength corresponds to a desired frequency where an RF payload should operate, or where a radar should not sense the tether.

In another embodiment, the tri-axial cable as described above, at one or more locations, go around or through a ferrite material one or more times; wherein the ferrite material is a block or cylindrical shape, and may have one or more holes through which the tri-axial cable may pass, such as a toroidal shape if the ferrite has a single hole.

In another embodiment, the sectioned tri-axial cable as described above, at one or more locations, is cut and the second shield is removed, making a gap in the second shield, while the power conductors that go to the payload side are connected to the secondary turns of a flux coupled transformer, and the power conductors that go to the ground station side are connected to the primary turns of that flux coupled transformer; wherein at each cut, the flux coupled transformer is comprised of primary turns and secondary turns on or through a ferrite material.

In another embodiment, the power conductors in the tether are formed from a sectioned shielded pair of wires, where the pair of wires is comprised of a first wire and a second wire which may be twisted, and where one side of the power is conducted via the first wire, the other side of the power is conducted via the second wire, and where the shield is cut into one or more section-pairs, that are comprised of either a first section-pair or a second section-pair, where a first section pair is comprised of a gap section where the shield is removed, and a continuous section, nominally ¼ wavelength or less long, with one end of the continuous section shorted to the first wire, and with the other end of the continuous section connecting to nothing, and where a second section-pair is comprised of a gap section where the shield is removed, and a continuous section nominally ¼ wavelength or less long, with one end of the continuous section shorted to the second wire, and with the other end of the continuous section connecting to nothing, wherein the said wavelength corresponds to a desired frequency where an RF payload should operate, or where a radar should not sense the tether. This embodiment has advantages in that (1) the first and second wires can be equally large and have a large current carrying capacity, (2) the shield can be very lightweight as it carries no power-supply current, and (3) it can be used with or without heavy ferrite, depending on what is best for a particular application and its frequency range.

In one embodiment, the one or more section-pairs alternate between being a first section-pair and a second section-pair as described above.

In another embodiment, the sectioned shielded pair of wires as described above, at one or more locations, go around or through a ferrite material one or more times; wherein the ferrite material is a block or cylindrical shape, and may have one or more holes through which the sectioned shielded pair of wires may pass, such as a rounded or rectangular toroidal shape if the ferrite has a single hole.

In another embodiment, the sectioned shielded pair of wires as described above, at one or more locations, is cut and the shield is removed, making a gap, while the power conductors that go to the payload side are connected to the secondary turns of a flux coupled transformer, and the power conductors that go to the ground station side are connected to the primary turns of that flux coupled transformer; wherein at each cut, the flux coupled transformer is comprised of primary turns and secondary turns around or through a ferrite material.

To summarize, the disclosed system uses a tethered aircraft in which power is provided to the aircraft through a tether with two or more sections, wherein at least one section is an RF-isolating section which includes a magnetic-choke section, an open-stub-transmission-line section, an open-stubbed-magnetic-choke section, or a magnetic-flux-coupled section, wherein
a. a magnetic-choke section is comprised of all the conductors in the tether wound in a coil, or around or through a high mu core, to form a choke that inhibits RF current from flowing through the magnetic choke-section,
b. an open-stub-transmission-line section is comprised of a multiconductor cable, having a first and second end, configured to have a conductive outer-shield surrounding the other conductors, and having inner conductors, at least two of which conduct power, wherein, either
   i. in a first case,
      1. one of the inner conductors (inner shield), surrounds the other inner conductors;
      2. the outer shield connects to the inner shield at the first end of the open-stub-transmission-line section, and
      3. the outer shield connects to nothing at the second end of the open-stub-transmission-line section; or
   ii. in a second case,
      1. at least one inner conductor and the outer shield, at the first end of the open-stub-transmission-line section, are coupled together at RF, including by capacitive coupling or by direct connection, and
      2. the outer shield connects to nothing at the second end of the open-stub section; and
c. an open-stubbed-magnetic-choke section is comprised of one or more series connected open-stub-transmission-line sections wound in a coil, or around or through a high mu core, to form a choke that inhibits RF current from flowing through the open-stubbed-magnetic-choke section; and
d. a magnetic-flux-coupled section is comprised of a flux coupled transformer wherein
   1. the tether's power conductors that go to the aircraft side are connected to the secondary side of the flux coupled transformer, and
   2. the tether's power conductors that go to the ground-station side are connected to the primary side of the flux coupled transformer.

In some embodiments, it is possible to have an end of an RF-isolating section located less than 1 wavelength from the aircraft, wherein the wavelength corresponds to a frequency where a radar should not detect the tether or where RF equipment on or near the aircraft should operate without impact from the tether.

In some embodiments, it is possible to have the magnetic-choke section or the open-stubbed-magnetic-choke section wound on a core material with mu greater than 2. And the core can take on shapes including: a block, a cylindrical shape, a shape with one or more holes through it, through which the conductors may pass, such as a toroidal shape, or two side-by-side toroids to form a two-hole shape.

In some embodiments, it is possible to have the power provided to the UAV through the tether using alternating current (AC), and one or more sections comprised of magnetic-flux-coupled sections.

In some embodiments, as described as an alternative to the system of FIG. 11, it is possible that at least one of the inner conductors, comprises an RF-conductor used to conduct an RF signal to an antenna, the antenna being formed by three sequential sections, a first antenna section, an RF-isolating section, and a second antenna section, where the RF-isolating section has a first side going to the first antenna section, and has a second side going to the second antenna section, where the RF-conductor from the first side of the RF-isolating section connects to the outer-shield of the second antenna section.

In some embodiments, as described as an alternative to the system of FIG. 11, it is possible that at least one of the inner conductors, comprises an RF-conductor used to conduct an RF signal to an antenna, the antenna being formed by four sequential sections, a first antenna section, a first RF-isolating section, a second antenna section, and a second RF-isolating section, where the RF-isolating section has a first side going the to the first antenna section, and has a second side going to the second antenna section, where the RF-conductor from the first side of the first RF-isolating section connects to the outer-shield of the second antenna section.

In some embodiments, as described as an alternative to the system of FIG. 11, it is possible that at least one of the inner conductors, comprises an RF-conductor used to conduct an RF signal to an antenna, the antenna being formed by five sequential sections, a first RF-isolating section, a first antenna section, a second RF-isolating section, a second antenna section, and a third RF-isolating section, where the second RF-isolating section has a first side going the to the first antenna section, and has a second side going to the second antenna section, where the RF-conductor from the first side of the second RF-isolating section connects to the outer-shield of the second antenna section.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. A tether system, comprising:
a multi-conductor tether, including
a first interval that is a first radio-frequency-isolating interval which includes at least one of: a first magnetic-choke section, a first open-stub-transmission-line section, a first open-stubbed-magnetic-choke section, or a first magnetic-flux-coupled section, and
a multi-conductor cable connected to the first interval.

2. The tether system of claim 1, wherein
the multi-conductor tether is configured to conduct power from a ground-based power source to an aircraft.

3. The tether system of claim 1, wherein
the magnetic-choke section includes a length of the multi-conductor cable that passes through or is wound around a core, to form a choke that inhibits radio frequency current from flowing through the magnetic choke-section.

4. The tether system of claim 3, wherein
the core is a high mu core.

5. The tether system of claim 3, wherein
the core is an air core.

6. The tether system of claim 3, wherein
the core is a resistive or ferrite-loaded bendable material.

7. The tether system of claim 1, wherein
the open-stub-transmission-line section includes a short length of the multi-conductor cable with a first and second end, with the multi-conductor cable having an outer conductor configured as a conductive outer-shield surrounding a plurality of inner conductors, at least two of which conduct power,
the outer conductor connects to a first inner conductor selected from one of the inner conductors at the first end of the open-stub-transmission-line section, and
the outer conductor connects to nothing conductive at the second end of the open-stub-transmission-line section.

8. The tether system of claim 1, wherein
the open-stub-transmission-line section includes a short length of the multi-conductor cable with a first end and a second end, with the multi-conductor cable having an outer conductor configured as a conductive outer shield surrounding a plurality of inner conductors, at least two of which conduct power,
at least one inner conductor and the outer conductor, at the first end of the open-stub-transmission-line section, are coupled together at radio frequency, and
the outer conductor connects to nothing conductive at the second end of the open-stub section.

9. The tether system of claim 7, wherein
the coupling of the at least one inner conductor and the outer conductor is by a direct conductive connection.

10. The tether system of claim 7, wherein
the coupling of the at least one inner conductor and the outer conductor is by capacitive coupling.

11. The tether system of claim 1, wherein
the open-stubbed-magnetic-choke section includes one or more series-connected open-stub-transmission-line sections passing through a core or wound in a coil around core, to form a choke that inhibits radio frequency current from flowing through the open-stubbed-magnetic-choke section.

12. The tether system of claim 11, wherein
the core is a high mu core.

13. The tether system of claim 11, wherein
the core is an air core.

14. The tether system of claim 1, wherein
the magnetic-flux-coupled section includes a flux-coupled transformer, with a primary side and a secondary side, where the primary side connects to a power conductor that conducts power through a path leading to the ground-based power source, and where the secondary side conducts power through a path leading to the voltage converter on the aircraft, and
the multi-conductor tether includes
a first power conductor,
a second power conductor, and
the second power conductor is connected to a primary side of the flux-coupled transformer.

15. The tether system of claim 14, wherein
the multi-conductor tether is configured to conduct power from a ground-based power source to an aircraft.

16. The tether system of claim 15, wherein
the first power conductor is located on an aircraft side of the flux-coupled transformer, and
the second power conductor is located on a ground-based-power-source side of the flux coupled transformer.

17. The tether system of claim 1, wherein
an end of a radio-frequency-isolating section is located less than 1 wavelength from the aircraft, and
the wavelength corresponds to a frequency where a radar should not detect the tether or where radio frequency equipment on or near the aircraft should operate without impact from the tether.

18. The tether system of claim 1, wherein
the magnetic-choke section or the open-stubbed-magnetic-choke section is wound on a core material with mu greater than 2.

19. The tether system of claim 1, wherein
the magnetic-choke section or the open-stubbed-magnetic-choke section is wound on a core material with mu greater than 2, and is shaped in one of:
a block,
a cylinder,
a toroid,
a non-toroidal shape with one or more holes through it, through which the conductors may pass, or
two side-by-side toroids to form a two-hole shape.

20. The tether system of claim 1, wherein
the tether uses at least one magnetic-flux-coupled section and is configured to provide power from a ground-based power source to an aircraft using alternating current.

21. The tether system of claim 1, wherein
at least one of the inner conductors comprises a radio-frequency-conductor configured to conduct a radio frequency signal to an antenna, the antenna being formed by three sequential sections:
a first antenna section,
a radio-frequency-isolating section, and
a second antenna section,
wherein
the radio-frequency-isolating section has a first side passing to the first antenna section, and has a second side passing to the second antenna section, and
the radio-frequency-conductor from the first side of the RF-isolating section connects to the outer-shield of the second antenna section.

22. The tether system of claim 1, wherein
at least one of the inner conductors comprises a radio-frequency-conductor configured to conduct a radio frequency signal to an antenna,
the antenna is formed by four sequential sections:
a first antenna section,
a first radio-frequency-isolating section,
a second antenna section, and
a second radio-frequency-isolating section,
the radio-frequency-isolating section has a first side passing to the first antenna section, and has a second side passing to the second antenna section, and
the radio-frequency-conductor from the first side of the first radio-frequency-isolating section connects to the outer-shield of the second antenna section.

23. The tether system of claim 1, wherein
at least one of the inner conductors comprises a radio-frequency-conductor used to conduct a radio frequency signal to an antenna,
the antenna is formed by five sequential sections:
a first radio-frequency-isolating section,
a first antenna section,
a second radio-frequency-isolating section,
a second antenna section, and
a third radio-frequency-isolating section,
the second radio-frequency-isolating section has a first side passing to the first antenna section, and has a second side passing to the second antenna section, and
the radio-frequency-conductor from the first side of the second radio-frequency-isolating section connects to the outer-shield of the second antenna section.

24. The tether system of claim 1, further comprising:
a second interval that is a radio-frequency-isolating section interval which includes at least one of: a magnetic-choke section, an open-stub-transmission-line section, an open-stubbed-magnetic-choke section, or a magnetic-flux-coupled section,
wherein a length of the multi-conductor cable extends between the first and the second intervals.

25. A method of powering an aircraft system, comprising:
forming a multi-conductor tether, including a first section interval that is a radio-frequency-isolating section interval which includes at least one of: a magnetic-choke section, an open-stub-transmission-line section, an open-stubbed-magnetic-choke section, or a magnetic-flux-coupled section, and
connecting a multi-conductor cable to the first section interval.

26. The method of claim 25, wherein
the multi-conductor tether is configured to conduct power from a ground-based power source to an aircraft.

27. The method of claim 24, further comprising:
forming a second section interval that is a second radio-frequency-isolating section interval which includes at least one of: a second magnetic-choke section, a second open-stub-transmission-line section, a second open-stubbed-magnetic-choke section, or a second magnetic-flux-coupled section, and
connecting the multi-conductor cable to the second section interval.
